(19) United States
(12) Patent Application Publication
(10) Pub. No.: US 2002/0027102 A1
(43) Pub. Date: Mar. 7, 2002

(54) Filter cartridges with pleated filter media

(76) Inventor: Norman F. Robillard, Sparks, MD (US)

Correspondence Address: NIXON & VANDERHYE P.C., 8th Floor, 1100 North Glebe Road, Arlington, VA, 22201, US

(21) Appl. No.: 09/904,100

(22) Filed: Jul. 13, 2001

Related U.S. Application Data
(63) Continuation-in-part of application No. 09/616,066, filed on Jul. 13, 2000.

(51) Int. Cl. B01D 27/00; B01D 35/00

(52) U.S. Cl. 210/493.1; 210/483; 210/485

(57) ABSTRACT

Filter cartridges include a pleated multi-layer filter media having a filtration membrane layer, and a structural support layer for the membrane layer which is in the form of an expanded polymeric film mesh. Most preferably, the membrane layer and the expanded polymeric film support layer are each formed of a fluoropolymer, most preferably PTFE. The preferred expanded polymeric film support layer is in the form of a relatively open mesh structure having generally diamond-shaped apertures. Improved flow rate characteristics through pleated filter media ensue when the diamond-shaped apertures of the mesh are oriented such that the long dimensions (LD) thereof are substantially transverse to the elongate pleat axis of the pleated filter medium in which the mesh is employed.

### CROSS-REFERENCE TO RELATED APPLICATION

This application is a continuation-in-part (CIP) of copending, commonly owned U.S. patent application Ser. No. 09/616,066 filed on Jul. 13, 2000, the entire content of which is expressly incorporated hereinto by reference.

### FIELD OF THE INVENTION

The present invention relates generally to the field of filter cartridges. More particularly, the present invention relates to filter cartridges which include pleated filter media.

### BACKGROUND AND SUMMARY OF THE INVENTION

Filter cartridges having pleated filter media are well known in the filtration art. Recently, U.S. Pat. No. 5,855,783 (the entire content of which is expressly incorporated hereinto by reference) has proposed a filter cartridge formed entirely of polytetrafluoroethylene (PTFE) wherein the pleated filter media is in the form of a pleated structure comprised of an inner PTFE membrane layer sandwiched between a pair of PTFE nonwoven paper layers which provide support for the inner PTFE membrane layer.

While the filter cartridge of the U.S. '783 patent is entirely satisfactory for its intended purpose, some improvements are still desirable. For example, it would be desirable to provide an all-fluoropolymer filter cartridge of the variety disclosed in the U.S. '783 patent, except that the filter media is formed of a pleated structure that is more cost efficient while yet retaining at least similar functional attributes thereof. It is towards providing such a filter cartridge that the present invention is directed.

Broadly, the present invention is embodied in a filter cartridge having a pleated multi-layer filter media, wherein the filter media includes a filtration membrane layer, and a structural support layer for the membrane layer which is in the form of an expanded polymeric film mesh. Most preferably, the membrane layer and the expanded polymeric film support layer are each formed of a fluoropolymer, most preferably PTFE. The preferred expanded polymeric film support layer is in the form of a relatively open mesh structure having generally diamond-shaped apertures.

In accordance with a particularly preferred aspect of the present invention, these diamond-shaped apertures are present in the mesh as a dense plurality and are symmetrically disposed, but off-set relative to one another. Each such diamond-shaped aperture is most advantageously configured so as to have a long dimension (LD) and a short dimension (SD). Surprisingly, it has been found that improved flow rate characteristics through pleated filter media ensue when the diamond-shaped apertures of the mesh are oriented such that the long dimensions (LD) thereof are substantially transverse to the elongate pleat axis of the pleated filter medium in which the mesh is employed.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein;

FIG. 1 is a perspective view, partly sectioned and exploded, of a filter cartridge in accordance with the present invention; and

FIG. 2 is a greatly enlarged plan view of an exemplary expanded polymeric film support layer that may be employed in the filter cartridges of the present invention.

### DETAILED DESCRIPTION OF THE INVENTION

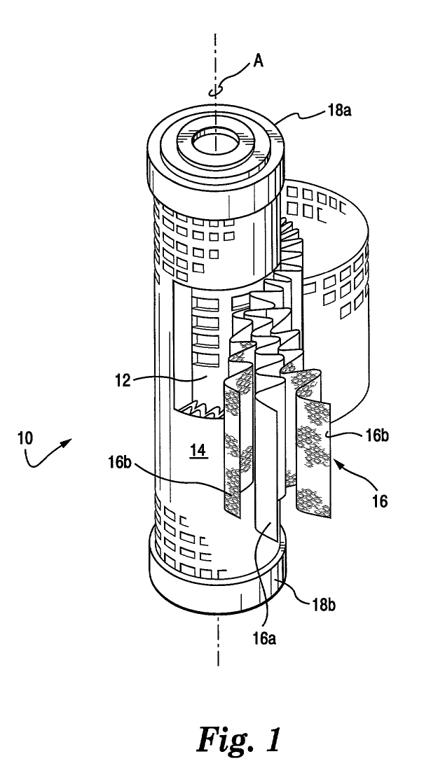

Accompanying FIG. 1 depicts an especially preferred filter cartridge 10 in accordance with the present invention. As is shown, the filter cartridge generally includes concentrically arranged cylindrical slotted core and cage elements, 12, 14, respectively between which the pleated filter media 16 is positioned. Suitable end caps 18a, 18b are provided to allow the filter cartridge to be functionally provided as a part of a filtration housing or system (not shown).

The pleated filter media 16 is a multilayer structure which is most preferably provided by an inner filter membrane layer 16a which is sandwiched between a pair of apertured support layers 16b. The preferred filter membrane layer 16a is a PTFE membrane which is made microporous by stretching (typically biaxially) a PTFE film to create micropores therein. PTFE membranes that may be sued are available commercially with a range of properties, such as pore diameter, thickness, engineering properties and the like. One particularly preferred PTFE membrane that may be employed in the practice of the present invention is available commercially from W.L. Gore & Co., Inc., under the registered trademark GORETEX®.

Each of the support layers 16b is most preferably an expanded polymeric film mesh formed by the substantially simultaneous cross-machine direction slitting and machine direction stretching of a polymeric film (e.g., PTFE film). Most preferably, the mesh support layers 16b are made by techniques generally employed to produce expanded metal mesh structures as disclosed, for example, in U.S. Pat. Nos. 3,607,411 and 3,760,470 (the entire content of each being incorporated hereinto expressly by reference). A preferred PTFE expanded mesh polymeric film for use as the support layer 16b may be obtained commercially from Exmet Corporation of Naugatuck, Conn.

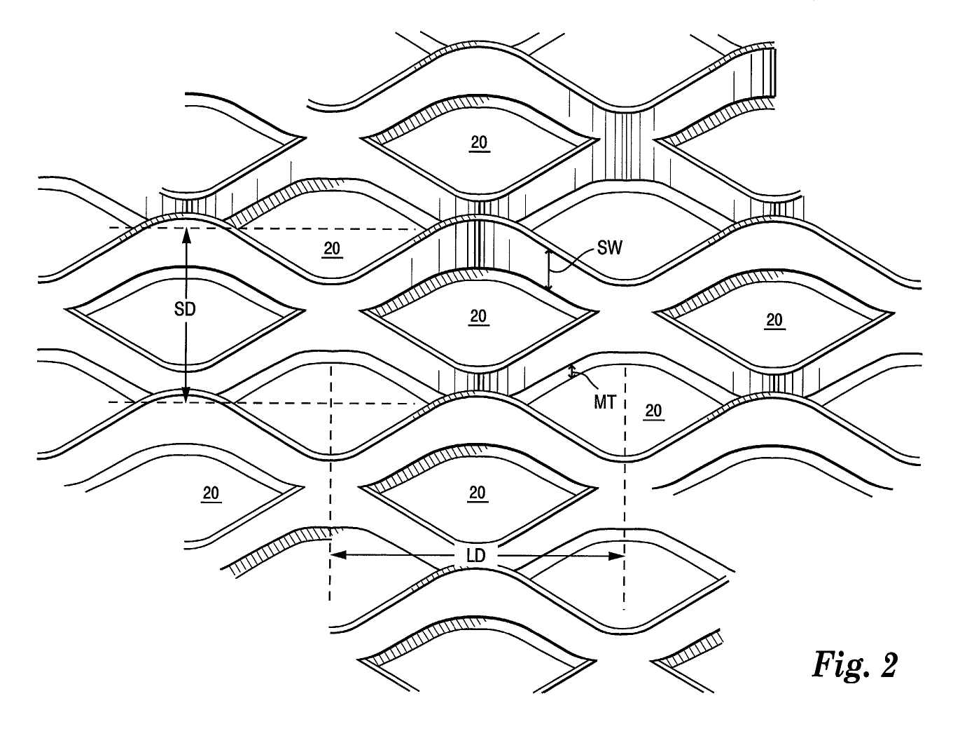

Accompanying FIG. 2 shows in a greatly enlarged manner, one particularly preferred form of the support layers 16b employed in the filter cartridges 10 according to the present invention. Although a variety of mesh shapes and dimensions may be employed successfully, the support layer 16b is most preferably provided with a dense plurality of symmetrically disposed, off-set, diamond-like apertures (a few of which are identified by the reference numeral 20 in FIG. 2) having a long dimension LD and a short dimension SD as depicted.

The long dimension LD of the apertures 20 is measured generally from the center of one joint between adjacent apertures 20 to the center of the next joint in the cross-machine (widthwise) direction of the non-apertured polymeric film. The long dimension LD is governed generally by the slit die that is employed to initially slit the non-apertured polymeric film. The short dimension SD is measured generally from the center of one joint between adjacent apertures 20 to the center of the next join in the machine (lengthwise) direction of the non-apertured film. Thus, the mesh count (i.e., openings per unit length of the support layer 16b) will decrease with an increase in the short dimension SD. Most preferably, the apertures 20 will be present in sufficient number and with long and short dimensions LD, SD, respectively, so that the support layer 16b exhibits at least about 40% open area, and typically less than about 90% open area. Most preferably, the support layer 16b exhibits an open area of between about 50% to about 60%.

The original material thickness MT is most preferably chosen so as to achieve the desired mesh configuration with the desired long and short dimensions LD, SD, respectively. The original material thickness MT will also determine the strand width SW defining the apertures 20 and the overall relative thickness of the layers 16b. According to the present invention, the strand width SW, and hence the relative thickness of the layers 16b, is most preferably less than about 2 mm, and preferably between about 0.075 mm to about 0.125 mm. Usually, the layer 16b will have a strand width (relative thickness) of about 1 mm.

The apertured support layers 16b are most preferably disposed in the pleated filter media 16 in such a manner that the long dimensions (LD) of the diamond-shaped apertures 20 are oriented substantially transverse (i.e., at substantially right angle) to the elongate axis of the individual pleats which elongate pleat axis is substantially parallel to the elongate central axis A (see FIG. 1) of the cylindrical filter cartridge 10 in which the pleated filter media 16 is disposed. In this regard, it has surprisingly been found that improved flow rate characteristics through pleated filter media 16 ensue when the diamond-shaped apertures 20 are oriented in such a manner.

The particular mesh configuration and/or thickness is selected for the particular end-use application expected to be encountered by the filter cartridge 10 during use. For example, the particular mesh configuration and/or thickness of the polymeric film mesh layers 16b may be selected so as to achieve sufficient pleat rigidity to ensure that the pleats do not collapse or fold over as the pressure drop across the filter increases. Furthermore, the particular mesh configuration and/or thickness of the layers 16b may alternatively, or additionally, be selected so as to provide adequate spacing between the pleats to ensure adequate fluid flow.

The optimum mesh configuration and/or thickness of the support layers 16b for a given end-use application is a function of the inherent rigidity and permeability of the filter media itself. A relatively stiff filter media will require less in the way of additional structural support whereas a relatively highly permeable filter media will require a more generous spacing between pleats to accommodate the flow. Within the parameters noted above, therefore, those skilled in this art may select a particular one or combination of mesh supports in order to satisfy particular end-use applications.

The present invention will be further understood from the following non-limiting Examples.

### EXAMPLES

Individual filter cartridges similar to those shown in FIG. 1 were tested with three different types of pleated filter media each having a “high flow” 0.05 μm PTFE (Teflon® fluoropolymer, DuPont) membrane and a total of 125 pleats. The PTFE membrane was respectively sandwiched between support structures of nonwoven PTFE fibers and two different types of expanded PTFE support mesh each having diamond-shaped apertures as depicted in FIG. 2. One type of expanded PTFE support mesh (Type 1) had the long dimensions (LD) of the apertures oriented in parallel alignment with the pleat axes, while the other type of expanded PTFE support mesh (Type 2) had the long dimensions (LD) of the apertures oriented substantially transverse to the pleat axes. Each such filter cartridge was tested for flow rate characteristics therethrough with the results appearing in Table 1 below.

TABLE 1

| Support Structure | Flow Rate (gpm/psi) |
|---|---|
| Non-Woven PTFE | 1.94 |
| Type 1 PTFE Mesh | 0.84 |
| Type 2 PTFE Mesh | 3.20 |

As can be seen from the data in Table 1, the orientation of the long dimensions (LD) of the diamond-shaped apertures of the Type 2 PTFE support mesh resulted in substantially higher flow rate characteristics as compared to both the non-woven PTFE and the Type 1 PTFE support structures.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A filter cartridge having a multilayer pleated filter media comprised of a filter membrane layer, and at least one support layer for the filter membrane layer, wherein said at least one support layer is an expanded polymeric film mesh.

2. The filter cartridge of claim 1, wherein said filter media includes a pair of said support layers which sandwich said filter membrane layer therebetween.

3. The filter cartridge of claim 1 or 2, wherein said expanded polymeric film mesh is formed of a dense plurality of generally diamond-shaped apertures.

4. The filter cartridge of claim 3, wherein said expanded polymeric film exhibits an open area of at least about 40%.

5. The filter cartridge of claim 4, wherein said expanded polymeric film exhibits an open area of between about 50% to about 60%.

6. The filter cartridge of claim 4, wherein said filter membrane layer and said expanded polymeric film each consists of polytetrafluoroethylene.

7. A filter cartridge comprising concentrically disposed slotted core and cage members, and a multilayer pleated filter media positioned in an annular space established between said core and cage members, wherein said filter media includes an inner filter membrane layer sandwiched between a pair of support layers for the filter membrane layer, wherein each said support layer is an expanded polymeric film mesh.

8. The filter cartridge of claim 7, wherein said expanded polymeric film mesh is formed of a dense plurality of generally diamond-shaped apertures.

9. The filter cartridge of claim 8, wherein said expanded polymeric film exhibits an open area of at least about 40%.

10. The filter cartridge of claim 8, wherein said expanded polymeric film exhibits an open area of between about 50% to about 60%.

11. The filter cartridge of claim 7, wherein said filter membrane layer and said expanded polymeric film each consist of polytetrafluoroethylene.

12. The filter cartridge of claim 1 or 7, wherein
pleats of the multilayer pleated filter media have elongate pleat axes disposed substantially parallel to a central longitudinal axis of the filter cartridge, and wherein
said expanded polymeric film mesh is formed of a dense plurality of generally diamond-shaped apertures having respective long and short dimensions; and wherein
said expanded polymeric film mesh is disposed such that said long dimensions of said diamond-shaped apertures thereof are oriented substantially transverse to said elongate pleat axes of the pleated filter media.

13. The filter cartridge of claim 12, wherein said filter media includes a pair of said support layers which sandwich said filter membrane layer therebetween.

14. The filter cartridge of claim 12, wherein each of said filter membrane layer and said expanded polymeric film consists of polytetrafluoroethylene.

15. The filter cartridge of claim 12, wherein said expanded polymeric film exhibits an open area of at least about 40%.

16. A generally cylindrical filter cartridge comprising:
an inner core member,
an outer cage member concentrically positioned around said inner core member so as to establish an annular space therebetween, and
multilayer pleated filter media positioned in said annular space established between said core and cage members, wherein said filter media includes a filter membrane layer and at least one expanded polymeric film mesh as a support layer for the filter membrane layer; wherein
pleats of the multilayer pleated filter media have elongate pleat axes disposed substantially parallel to a central longitudinal axis of the filter cartridge, and wherein
said expanded polymeric film mesh is formed of a dense plurality of generally diamond-shaped apertures having respective long and short dimensions; and wherein said expanded polymeric film mesh is disposed such that
said long dimensions of said diamond-shaped apertures thereof are oriented substantially transverse to said elongate pleat axes of the pleated filter media.

17. The filter cartridge of claim 16, wherein said filter media includes a pair of said expanded polymeric mesh as support layers which sandwich said filter membrane layer therebetween.

18. The filter cartridge of claim 16, wherein each of said filter membrane layer and said expanded polymeric film consists of polytetrafluoroethylene.

19. The filter cartridge of claim 18, wherein each of said inner core and outer cage members consists of polytetrafluoroethylene.

20. The filter cartridge of claim 16, wherein said expanded polymeric film exhibits an open area of at least about 40%.
